(19) United States
(12) Patent Application Publication
(10) Pub. No.: US 2015/0022766 A1
(43) Pub. Date: Jan. 22, 2015

(54) LIQUID CRYSTAL DISPLAY

(71) Applicant: Samsung Display Co., Ltd., Yongin-City (KR)

(72) Inventors: Hyun Wuk KIM, Yongin-si (KR); Sung In RO, Hwaseong-si (KR); Ock Soo SON, Seoul (KR); Jean Ho SONG, Yongin-si (KR); Eun Je JANG, Hwaseong-si (KR)

(73) Assignee: Samsung Display Co., Ltd., Yongin-City (KR)

(21) Appl. No.: 14/058,457

(22) Filed: Oct. 21, 2013

(30) Foreign Application Priority Data
Jul. 17, 2013 (KR) 10-2013-0084334

(51) Int. Cl. G02F 1/1335

(52) U.S. Cl. CPC G02F 1/133512; G02F 1/133514
USPC 349/106; 349/110

(57) ABSTRACT

A liquid crystal display includes a first substrate and a second substrate which face opposite to each other, a thin film transistor disposed on the first substrate, a pixel electrode connected to the thin film transistor, a first light blocking member disposed on the pixel electrode, and a cover layer disposed on the first light blocking member and covering the first light blocking member.

This application claims priority to Korean Patent Application No. 10-2013-0084334 filed on Jul. 17, 2013, and all the benefits accruing therefrom under 35 U.S.C. §119, the entire contents of which are incorporated herein by reference.

### BACKGROUND

(1) Field

The invention relates to a liquid crystal display, and more particularly, to a liquid crystal display in which a light blocking member and a thin film transistor are positioned on the same substrate.

(2) Description of the Related Art

A liquid crystal display (“LCD”) device which is currently one of the most common types of flat panel displays, typically includes two sheets of panels with field generating electrodes and a liquid crystal layer interposed therebetween. The LCD rearranges liquid crystal molecules of the liquid crystal layer by applying a voltage to the field generating electrodes to control an amount of transmitted light, thereby displaying a desired image.

The field generating electrodes may be provided in two panels facing each other, and two field generating electrodes may be positioned on one panel. A pixel electrode receiving a data voltage of the field generating electrodes and a plurality of thin film transistors (“TFTs”) are arranged in a matrix form on one panel of the two panels facing each other, and color filters expressing primary colors such as red, green and blue, for example, and a light blocking member capable of effectively preventing light leakage between pixels may be disposed on the other panel.

However, in such an LCD, since the pixel electrode and the TFT, and the color filter or the light blocking member are disposed on the different panels, it is difficult to perform exact alignment between the pixel electrode and the color filter or between the pixel electrode and the light blocking member. As a result, an alignment error may occur.

In order to solve the alignment error, a structure in which the light blocking member is formed on the same panel as the pixel electrode and the TFT is provided, and in this case, the color filter may also be formed on the same panel as the pixel electrode. As such, by forming the light blocking member on the panel with the pixel electrode and the TFT together, a high aperture ratio and high transmittance of the LCD may be achieved.

### SUMMARY

However, in the structure in which the light blocking member is formed on the same panel as the pixel electrode and the thin film transistor (“TFT”), an impurity is injected into the liquid crystal layer from the light blocking member, and as result, an after image is generated and reliability of the liquid crystal display (“LCD”) may be deteriorated.

Therefore, the invention has been made in an effort to provide an LCD having advantages of removing an afterimage of the LCD and enhancing reliability by effectively preventing an impurity from flowing into a liquid crystal layer from a light blocking member, in the case where the light blocking member is disposed on the same panel as a pixel electrode and a TFT.

An exemplary embodiment of the invention provides an LCD including a first substrate and a second substrate facing each other; a TFT disposed on the first substrate; a pixel electrode connected to the TFT; a first light blocking member disposed on the pixel electrode; and a cover layer disposed on the first light blocking member and covering the first light blocking member.

The first light blocking member may include a pigment component, and the cover layer may not include the pigment component.

The cover layer may include at least one of a transparent organic insulating material and a transparent inorganic insulating material.

The cover layer may further include a spacer maintaining a separation distance between the first substrate and the second substrate.

The LCD may further include a first passivation layer disposed between the TFT and the pixel electrode, in which a contact hole may be defined in the first passivation layer to expose a drain electrode of the TFT, and the first light blocking member may include a portion covering the contact hole.

The LCD may further include a color filter disposed between the TFT and the pixel electrode.

A thickness of the cover layer may be equal to or greater than about 1 micrometer (μm).

The first light blocking member may include a spacer maintaining a separation distance between the first substrate and the second substrate.

The LCD may further include a second light blocking member disposed between the TFT and the pixel electrode.

A boundary of an opening defined in the second light blocking member may be wider than the contact hole.

The first light blocking member may further include a spacer maintaining a separation distance between the first substrate and the second substrate.

The LCD may further include a color filter disposed between the TFT and the pixel electrode.

The cover layer may include a portion covering a separated area between the portion of the first light blocking member covering the contact hole and the spacer.

The first light blocking member may be disposed on the second light blocking member.

The LCD may further include a color filter disposed between the TFT and the pixel electrode, in which the second light blocking member may include a portion having a smaller height than that of the color filter.

According to the exemplary embodiment of the invention, it is possible to remove an afterimage of the LCD and enhance reliability by effectively preventing an impurity from flowing into a liquid crystal layer from a light blocking member, in an LCD where the light blocking member is disposed on the same panel as a pixel electrode and a TFT.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a plan view for an exemplary embodiment of one pixel of a liquid crystal display (“LCD”) according to the invention.

FIG. 2 is an exemplary embodiment of a cross-sectional view of the LCD of FIG. 1 taken along line II-II.

FIG. 3 is another exemplary embodiment of a cross-sectional view of the LCD of FIG. 1 taken along line II-II.

FIG. 4 is a plan view of an exemplary embodiment of one pixel of an LCD according to the invention.

FIG. 5 is an exemplary embodiment of a cross-sectional view of the LCD of FIG. 4 taken along line V-V.

FIG. 6 is a cross-sectional view illustrating an exemplary embodiment of an LCD according to the invention.

FIG. 7 is a plan view of an exemplary embodiment of one pixel of an LCD according to the invention.

FIG. 8 is an exemplary embodiment of a cross-sectional view of the LCD of FIG. 7 taken along line VIII-VIII.

### DETAILED DESCRIPTION

The invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, a liquid crystal display (“LCD”) according to an exemplary embodiment of the invention will be described in detail with reference to the accompanying drawings.

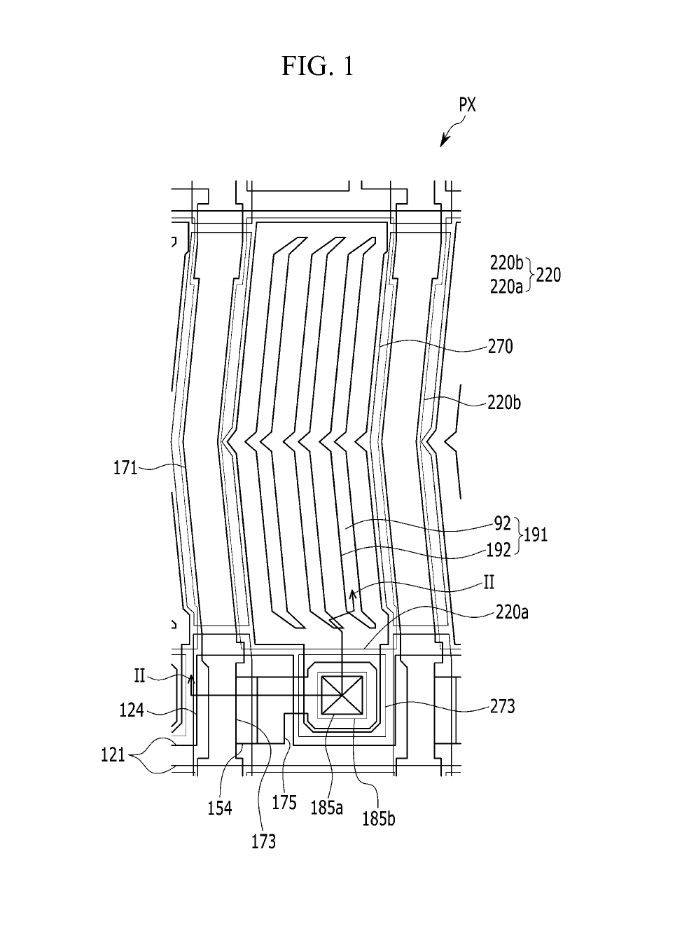

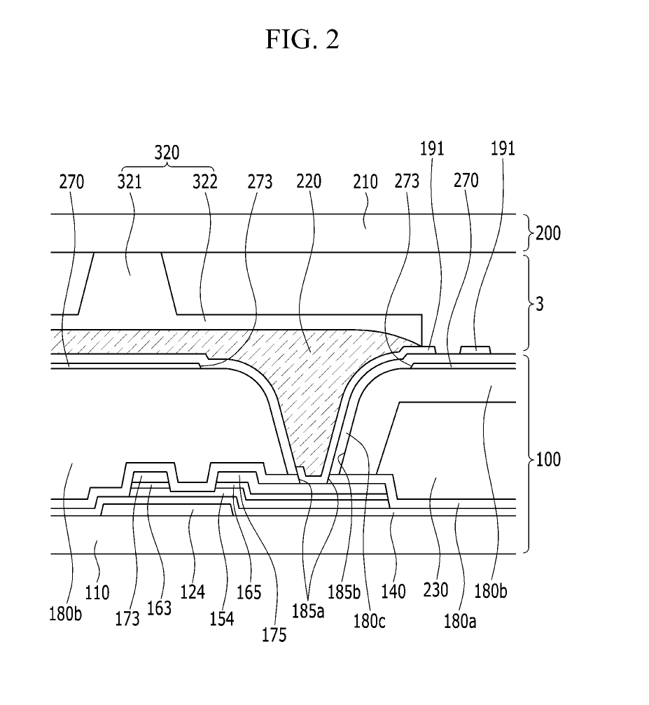

First, an LCD according to an exemplary embodiment of the invention will be described with reference to FIGS. 1 and 2.

FIG. 1 is a layout view illustrating an LCD according to an exemplary embodiment of the invention, and FIG. 2 is a cross-sectional view of an exemplary embodiment of the LCD of FIG. 1 taken along line II-II.

Referring to FIGS. 1 and 2, an LCD device according to an exemplary embodiment of the invention includes a lower panel 100 and an upper panel 200 facing each other, and a liquid crystal layer 3 interposed therebetween.

In an exemplary embodiment, the upper panel 200 includes an insulating substrate 210 including transparent glass or plastic.

Next, in the lower panel 100, a gate conductor including a plurality of gate lines 121 is disposed on the insulation substrate 110 including transparent glass or plastic.

The gate line 121 transfers a gate signal and may extend in a substantially horizontal direction. The gate line 121 includes a gate electrode 124. In an exemplary embodiment, the gate line 121 may include aluminum-based metal such as aluminum (Al) or an aluminum alloy, silver-based metal such as silver (Ag) or a silver alloy, copper-based metal such as copper (Cu) or a copper alloy, molybdenum-based metal such as molybdenum (Mo) or a molybdenum alloy, chromium (Cr), tantalum (Ta) and titanium (Ti). However, in another exemplary embodiment, the gate line 121 may have a multilayered structure including at least two conductive layers having different physical properties.

A gate insulating layer 140 including silicon nitride (SiNx) or silicon oxide (SiOx) is disposed on the gate conductor. In an exemplary embodiment, the gate insulating layer 140 may have a multilayered structure including at least two insulating layers having different physical properties.

A semiconductor 154 is disposed on the gate insulating layer 140. In an exemplary embodiment, the semiconductor 154 may include amorphous silicon, polysilicon and an oxide semiconductor.

Ohmic contacts 163 and 165 are disposed on the semiconductor 154. In an exemplary embodiment, the ohmic contacts 163 and 165 may include a material such as n+ hydrogenated amorphous silicon in which n-type impurity such as phosphorus is doped at a high concentration or silicide. The ohmic contacts 163 and 165 may be disposed on the semiconductor 154 as a pair. In the case where the semiconductor 154 is the oxide semiconductor, the ohmic contacts 163 and 165 may be omitted.

A data conductor including a data line 171 including a source electrode 173 and a drain electrode 175 is disposed on the ohmic contacts 163 and 165 and the gate insulating layer 140.

The data line 171 transfers a data signal and extends in a substantially vertical direction to cross the gate line 121.

The data line 171 may be curved at predetermined intervals in order to improve transmittance. In an exemplary embodiment, as illustrated in FIG. 1, each data line 171 may be curved at a portion corresponding to a horizontal center line (not illustrated) of one pixel PX, for example. In this case, an angle between a curved portion of the data lines 171 and the vertical direction may be approximately 5 degrees to approximately 7 degrees, but is not limited thereto. Further, the data line 171 may be further curved at least once around the horizontal center line, and in this case, an angle between the data line 171 around the horizontal center line and the vertical direction may be approximately 5 degrees to 7 degrees, but is not limited thereto.

The data line 171 includes the source electrode 173. According to the exemplary embodiment illustrated in FIG. 1, the source electrode 173 does not protrude from the data line 171, and may be disposed on a same line with the data line 171.

The drain electrode 175 faces the source electrode 173. In an exemplary embodiment, the drain electrode 175 may include a rod-shaped portion extending in substantially parallel with the source electrode 173 and an extension which is opposite thereto.

The data conductor may include refractory metal such as molybdenum, chromium, tantalum, and titanium or an alloy thereof, and may have a multilayered structure including a refractory metal layer (not illustrated) and a low resistive conductive layer (not illustrated). In an exemplary embodiment, the multilayered structure may include a double layer including a chromium or molybdenum (alloy) lower layer and an aluminum (alloy) upper layer, and a triple layer including a molybdenum (alloy) lower layer, an aluminum (alloy) intermediate layer and a molybdenum (alloy) upper layer. However, the invention is not limited thereto, and the data line 171 and the drain electrode 175 may include various metals or conductors in addition to the metals.

The gate electrode 124, the source electrode 173 and the drain electrode 175 are included in one thin film transistor (“TFT”) together with the semiconductor 154, and a channel of the TFT is disposed in the semiconductor 154 between the source electrode 173 and the drain electrode 175.

In the exemplary embodiment, the TFT includes the source electrode 173 disposed on the same line with the data line 171 and the drain electrode 175 extending in substantially parallel with the data line 171. As a result, a width of the TFT may be increased while an area of the data conductor is not increased, thereby further increases an aperture ratio of the LCD.

A first passivation layer 180a is disposed on the data conductor, the gate insulating layer 140 and an exposed portion of the semiconductor 154. The first passivation layer 180a may include an organic insulating material or an inorganic insulating material.

The color filter 230 may be disposed on the first passivation layer 180a. The color filter 230 may uniquely display one of the primary colors. In an exemplary embodiment, the primary colors may include three primary colors such as red, green and blue, three primary colors such as yellow, cyan and magenta or four primary colors. According to another exemplary embodiment of the invention, the color filter 230 may further include a color filter displaying a mixed color of the primary colors or white in addition to the primary colors. Each color filter 230 may be provided to be elongated along a pixel column or a pixel row.

A second passivation layer 180b is disposed on the color filter 230. The second passivation layer 180b may include an insulating layer or an organic insulator, and may effectively prevent the color filter 230 from being exposed, as an overcoat for the color filter 230, and provide a substantially flat surface. The second passivation layer 180b may effectively prevent an impurity such as a pigment of the color filter 230 from flowing into the liquid crystal layer 3.

An opening 185b may be defined in a region of the second passivation layer 180b which corresponds to a part of the drain electrode 175.

In another exemplary embodiment, the second passivation layer 180b may be omitted.

A common electrode 270 may be disposed on the second passivation layer 180b. The common electrode 270 may be disposed on an entire surface of the insulation substrate 110 with a plate as a planar shape. The common electrodes 270 disposed at adjacent pixels PX are connected to each other to transfer a common voltage having a predetermined magnitude. The common electrode 270 may include a transparent conductive material such as indium tin oxide (“ITO”) or indium zinc oxide (“IZO”).

An opening 273 may be defined in a region of the common electrode 270 which corresponds to a part of the drain electrode 175.

A third passivation layer 180c may be disposed on the common electrode 270. A third passivation layer 180c may include an organic insulating material or an inorganic insulating material. In an exemplary embodiment, the third passivation layer 180c may have a substantially flat surface.

A contact hole 185a exposing the drain electrode 175 is defined in the first passivation layer 180a and the third passivation layer 180c. As illustrated in the drawing, the contact hole 185a may be defined in the opening 185b of the second passivation layer 180b, and an outer boundary of the contact hole 185a and an outer boundary of the opening 185b may substantially coincide with each other. Further, the contact hole 185a is defined in the opening 273 of the common electrode 270. That is, the opening 273 of the common electrode 270 may be wider than the contact hole 185a.

A pixel electrode 191 is disposed on the third passivation layer 180c. The pixel electrode 191 includes a plurality of branch electrodes 192, a connection part (not illustrated) connecting ends of the branch electrodes 192, and a protrusion (not illustrated) for connection with another layer. A slit 92 in which a portion of the electrodes is omitted, is defined between the adjacent branch electrodes 192 of the pixel electrode 191.

The branch electrodes 192 of the pixel electrode 191 may extend to be substantially parallel to the data line 171. The plurality of branch electrodes 192 of the pixel electrode 191 may be tilted to provide an oblique angle with a vertical direction, and may be curved in a horizontal center line (not illustrated) of the pixel electrode 191. Accordingly, the pixel electrode 191 may be divided into a plurality of domains having different tilt directions of the branch electrodes 192 based on the horizontal center line of each pixel PX. In an exemplary embodiment, upper branch electrodes 192 may extend in an upper right direction based on the horizontal center line, and lower branch electrodes 192 may extend in a lower right direction, for example.

The protrusion of the pixel electrode 191 is physically and electrically connected with the drain electrode 175 through the contact hole 185a of the first passivation layer 180a and the third passivation layer 180c to receive a voltage from the drain electrode 175.

In an exemplary embodiment, the pixel electrode 191 may include a transparent conductive material such as ITO or IZO.

According to another exemplary embodiment of the invention, a laminated position of the pixel electrode 191 and the common electrode 270 may be changed. That is, the pixel electrode 191 may be disposed on the second passivation layer 180b, the third passivation layer 180c may be disposed on the pixel electrode 191, and the common electrode 270 may be disposed on the third passivation layer 180c. In this case, the contact hole 185a may not be defined in the third passivation layer 180c, and the opening 273 may not be defined in the common electrode 270. Further, the pixel electrode 191 may have a planer shape which fills most of the pixel PX area, and the common electrode 270 may include a plurality of branch electrodes (not illustrated) overlapped with the pixel electrode 191.

The pixel electrode 191 according to another exemplary embodiment of the invention is disposed on the lower panel 100, and the common electrode 270 may be disposed on the upper panel 200. In addition, the structure and the layout of the pixel electrode 191 and the common electrode 270 may be modified.

A light blocking member 220 is disposed on the pixel electrode 191. The light blocking member 220 is also referred to as a black matrix, and blocks light leakage between the pixels PX. The light blocking member 220 may include a pigment such as black carbon, and may include a photosensitive organic material.

The light blocking member 220 may include a portion disposed between substantially adjacent color filters 230. The light blocking member 220 may include a first light blocking part 220a covering the gate line 121 and extended to be substantially parallel to the gate line 121, and a second light blocking part 220b extended to be substantially parallel to the data line 171.

The first light blocking part 220a includes a portion covering a TFT, and a portion covering the contact hole 185a exposing the drain electrode 175. Accordingly, the light blocking member 220 fills up a large step around the contact hole 185a to planarize a surface. Further, the first light blocking part 220a covering the contact hole 185a may effectively prevent light leakage around the contact hole 185a.

In an exemplary embodiment, any one of the first light blocking part 220a and the second light blocking part 220b may be omitted.

Like the exemplary embodiment of the invention, the color filter 230 and the light blocking member 220 are disposed on the lower panel 100 together with the TFT. As a result, alignment between the light blocking member 220 and the color filter 230 and the pixel electrode 191 and the TFT may be easily adjusted, thereby effectively reduces an alignment error. Accordingly, it is possible to effectively prevent light leakage or deterioration of an aperture ratio of the LCD due to misalignment between the constituent elements and enhance transmittance.

A transparent cover layer 320 is disposed on the light blocking member 220.

The cover layer 320 covers the light blocking member 220 to effectively prevent a pigment component such as a halogen element as an impurity from flowing or diffusing into the liquid crystal layer 3 from the light blocking member 220. Accordingly, it is possible to effectively prevent an afterimage due to the impurity flowing into the liquid crystal layer 3 and enhance reliability of the LCD. To this end, the cover layer 320 may cover an entire surface of the exposed light blocking member 220.

The cover layer 320 does not include a pigment component, but may include a material without a reliability issue, for example, a transparent organic insulating material such as acrylate or a transparent inorganic insulating material. In the case where the cover layer 320 includes an organic insulating material, the cover layer 320 may include an organic insulating material having photosensitivity.

Referring to FIG. 2, the cover layer 320 may include a spacer 321 and a cover 322. The spacer 321 may maintain a separation distance between the lower panel 100 and the upper panel 200, and is also referred to as a spacer member. The cover 322 has a thickness smaller than that of the spacer 321 and may cover most of the light blocking member 220. As such, the cover layer 320 including the portions having different thicknesses may be provided by using one optical mask. In this case, the optical mask may include a light transmitting region transmitting light, a non-light transmitting region blocking the light and a half-tone region transmitting only a part of the light, and the half-tone region may correspond to the cover 322.

In an exemplary embodiment, the thickness of the cover 322 of the cover layer 320 may be equal to or greater than about 1 micrometer (μm), for example, but is not limited thereto.

Although not illustrated, an alignment layer is coated on the pixel electrode 191 and the third passivation layer 180c, and the alignment layer may be a horizontal alignment layer. The alignment layer may be rubbed in a predetermined direction. However, according to another exemplary embodiment of the invention, the alignment layer includes a photoreactive material to be photo-aligned.

The liquid crystal layer 3 includes liquid crystal molecules (not illustrated) having dielectric anisotropy. The liquid crystal molecules may be aligned so that long axes thereof are substantially parallel to the panels 100 and 200 without applying an electric field to the liquid crystal layer 3, and in this case, the liquid crystal molecules may have positive dielectric anisotropy. The liquid crystal molecule 31 may be a nematic liquid crystal molecule of which a long-axial direction is spirally twisted up to the upper panel 200 from the lower panel 100. According to another exemplary embodiment of the invention, the liquid crystal molecules may be aligned so that long axes thereof are vertical to the panels 100 and 200 without applying the electric field to the liquid crystal layer 3, and the liquid crystal molecules may have negative dielectric anisotropy. In this case, the layout and the structure of the pixel electrode 191 and the common electrode 270 may be accordingly modified unlike the exemplary embodiment illustrated in FIGS. 1 and 2.

The pixel electrode 191 may receive a data voltage from the TFT, and the common electrode 270 may receive a common voltage. Then, the pixel electrode 191 and the common electrode 270 as two field generating electrodes generate an electric field in the liquid crystal layer 3. As a result, the liquid crystal molecules of the liquid crystal layer 3 disposed between the two electrodes 191 and 270 are re-arranged. Polarization of light passing through the liquid crystal layer 3 varies according to the re-arranged liquid crystal molecules, and an image at desired luminance may be displayed. The branch electrodes 192 of the pixel electrode 191 according to the exemplary embodiment illustrated in FIGS. 1 and 2 provide a fringe field in the liquid crystal layer 3 together with the common electrode 270 to determine alignment directions of the liquid crystal molecules. Accordingly, like the exemplary embodiment of the invention, when the branch electrodes 192 included in one pixel electrode 191 have different directional slopes, tilt directions of the liquid crystal molecules 31 are various. As a result, a reference viewing angle of the LCD may be enlarged.

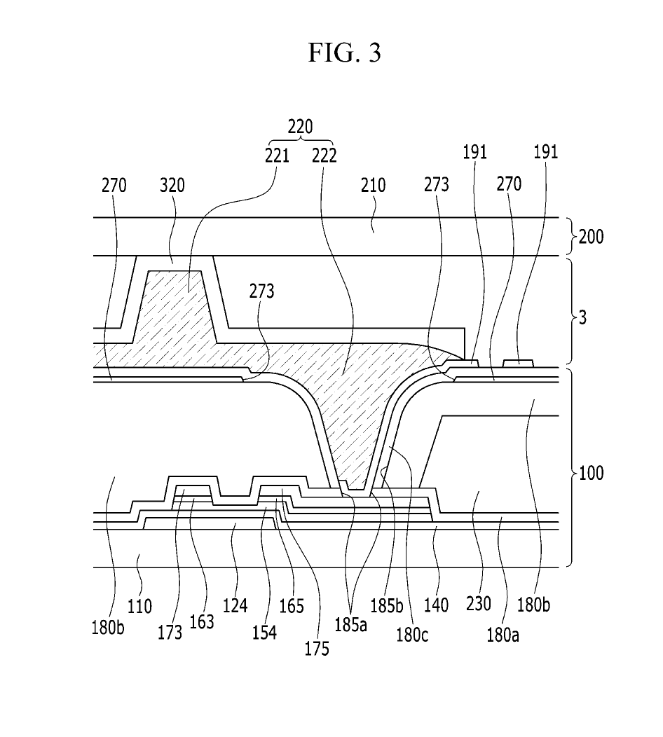

Then, an LCD according to an exemplary embodiment of the invention will be described with reference to FIG. 3 together with the drawings described above. FIG. 3 is another exemplary embodiment of a cross-sectional view of the LCD of FIG. 1 taken along line II-II.

Referring to FIG. 3, the LCD according to the exemplary embodiment is almost the same as the exemplary embodiment illustrated in FIGS. 1 and 2 described above, but the light blocking member 220 and the cover layer 320 may be different.

The light blocking member 220 may include portions having different thicknesses. In detail, the light blocking member 220 according to an exemplary embodiment of the invention may include a spacer 221 and a main light blocking part 222. The spacer 221 may maintain a separation distance between the lower panel 100 and the upper panel 200. The main light blocking part 222 may have a smaller thickness than the spacer 221. The main light blocking member 222 may include a first light blocking part 220a covering the gate line 121 and extended to be substantially parallel to the gate line 121, and a second light blocking part 220b covering the data line 171 and extended to be substantially parallel to the data line 171. The first light blocking part 220a includes a portion covering a TFT, and a portion covering the contact hole 185a exposing the drain electrode 175. Accordingly, the light blocking member 220 fills up a large step around the contact hole 185a to planarize a surface.

An upper surface of the main light blocking part 222 where the spacer 221 is not disposed may be substantially flat.

The light blocking member 220 may include a pigment such as black carbon, and may include a photosensitive organic material.

As such, the light blocking member 220 including the portions having different thicknesses may be provided by using one optical mask. In this case, the optical mask may include a light transmitting region transmitting light, a non-light transmitting region blocking the light and a half-tone region transmitting only a part of the light, and the half-tone region may correspond to the main light blocking part 222.

A transparent cover layer 320 is disposed on the light blocking member 220. The cover layer 320 covers the light blocking member 220 to effectively prevent a pigment component such as a halogen element as an impurity from flowing or diffusing into the liquid crystal layer 3 from the light blocking member 220. Accordingly, it is possible to effectively prevent an afterimage due to the impurity flowing into the liquid crystal layer 3 and enhance reliability of the LCD. To this end, the cover layer 320 may cover an entire surface of the exposed light blocking member 220.

The cover layer 320 does not include a pigment component, but may include a material without a reliability issue, for example, a transparent organic insulating material such as acrylate or a transparent inorganic insulating material. In the case where the cover layer 320 includes an organic insulating material, the cover layer 320 may include an organic insulating material having photosensitivity.

In an exemplary embodiment, the thickness of the cover layer 320 may be equal to or greater than about 1 μm, for example, but is not limited thereto.

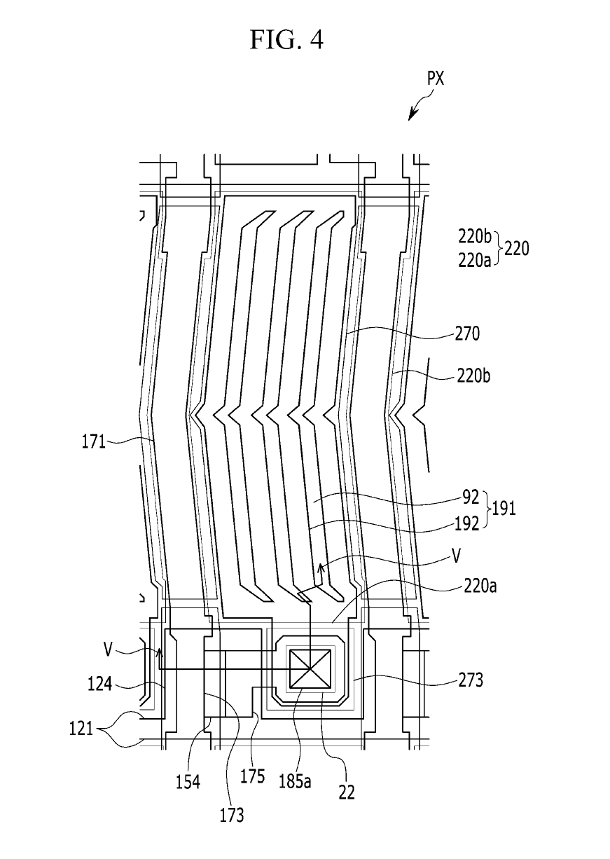

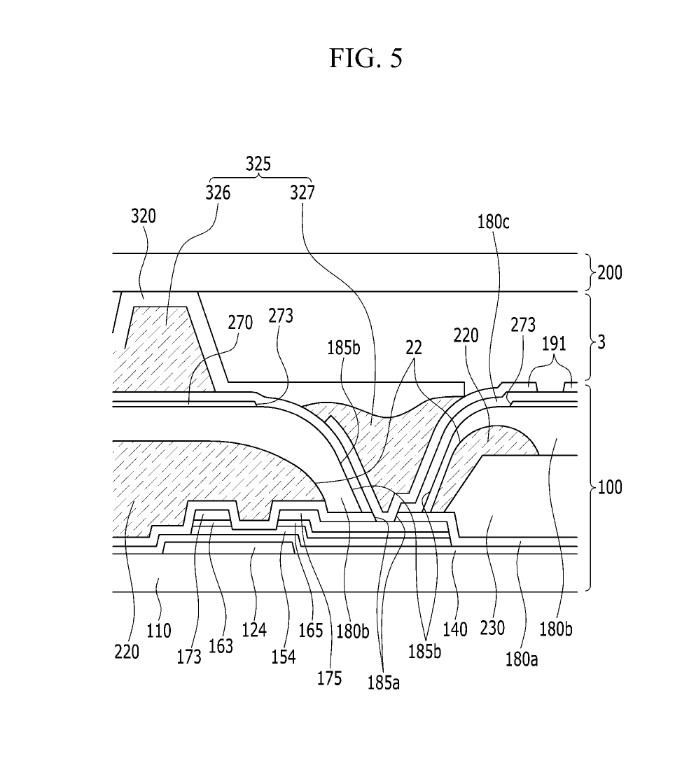

Next, an LCD according to an exemplary embodiment of the invention will be described with reference to FIGS. 4 and 5. The same constituent elements as the exemplary embodiment described above with reference to FIGS. 1 to 3 designate the same reference numerals, and a duplicated description is omitted, but differences will be mainly described.

FIG. 4 is a layout view illustrating one pixel of an LCD according to an exemplary embodiment of the invention, and FIG. 5 is an exemplary embodiment of a cross-sectional view of the LCD of FIG. 4 taken along line V-V.

Referring to FIGS. 4 and 5, the LCD according to the exemplary embodiment of the invention includes a lower panel 100 and an upper panel 200 facing each other, and a liquid crystal layer 3 interposed therebetween.

In the lower panel 100, a gate conductor including a plurality of gate lines 121 is disposed on an insulation substrate 110. The gate line 121 may include a gate electrode 124. A gate insulating layer 140 is disposed on a gate conductor, and the semiconductor 154 may be disposed on the gate insulating layer 140. Ohmic contacts 163 and 165 may be disposed on the semiconductor 154. A data conductor including a data line 171 including a source electrode 173 and a drain electrode 175 is disposed on the ohmic contacts 163 and 165 and the gate insulating layer 140. A first passivation layer 180a may be disposed on the data conductor, the gate insulating layer 140 and an exposed portion of the semiconductor 154.

A color filter 230 and a light blocking member 220 may be disposed on the first passivation layer 180a.

The color filter 230 may uniquely display one of the primary colors. Each color filter 230 may be provided to be elongated along a pixel column or a pixel row.

The light blocking member 220 may block light leakage between the pixels PX. The light blocking member 220 may include a pigment such as black carbon, and may include a photosensitive organic material. The light blocking member 220 may include a portion disposed between the substantially adjacent color filters 230. The light blocking member 220 may include a first light blocking part 220a covering the gate line 121 and extended to be substantially parallel to the gate line 121, and a second light blocking part 220b covering the data line 171 and extended to be substantially parallel to the data line 171.

The first light blocking part 220a includes a portion covering a TFT, and an opening 22 defined in a region corresponding to a part of the drain electrode 175.

Any one of the first light blocking part 220a and the second light blocking part 220b may be omitted.

A second insulating layer 180b may be disposed on the color filter 230 and the light blocking member 220. The second passivation layer 180b may include an inorganic insulating layer or an organic insulating layer, and may effectively prevent the color filter 230 and the light blocking member 220 from being exposed, as an overcoat for the color filter 230 and the light blocking member 220, and provide a substantially flat surface. The second passivation layer 180b may effectively prevent an impurity such as a pigment of the color filter 230 and the light blocking member 220 from flowing into the liquid crystal layer 3.

An opening 185b may be defined in a region of the second passivation layer 180b corresponding to a part of the drain electrode 175. The opening 185b of the second passivation layer 180b may be defined in the opening 22 of the light blocking member 220.

In another exemplary embodiment, the second passivation layer 180b may be omitted.

A common electrode 270 may be disposed on the second passivation layer 180b. The common electrode 270 may be disposed on an entire surface of the substrate 110 with a plate as a planar shape. The common electrodes 270 disposed at adjacent pixels PX are connected to each other to transfer a common voltage having a predetermined magnitude.

An opening 273 may be defined in a region of the common electrode 270 corresponding to a part of the drain electrode 175. In the exemplary embodiment illustrated in FIGS. 4 and 5, the opening 273 of the common electrode 270 is larger than the opening 22 of the light blocking member 220 to cover the opening 22. However, the invention is not limited thereto, and the opening 273 of the common electrode 270 may be smaller than the opening 22 of the light blocking member 220, and an outer boundary of the opening 273 of the common electrode 270 may be at least partially overlapped with an outer boundary of the opening 22 of the light blocking member 220.

A third passivation layer 180c may be disposed on the common electrode 270.

A contact hole 185a exposing the drain electrode 175 is defined in the first passivation layer 180a and the third passivation layer 180c. As illustrated in the drawing, the contact hole 185a may be defined in the opening 185b of the second passivation layer 180b, and an outer boundary of the contact hole 185a and an outer boundary of the opening 185b may substantially coincide with each other. Further, the contact hole 185a is defined in the opening 273 of the common electrode 270 and the opening 22 of the light blocking member 220. That is, the opening 273 of the common electrode 270 and the opening 22 of the light blocking member 220 may be wider than the contact hole 185a, respectively.

The pixel electrode 191 is disposed on the third passivation layer 180c. The pixel electrode 191 may include a plurality of branch electrodes 192 overlapped with the common electrode 270. A slit 92 where the electrodes are removed is defined between the adjacent branch electrodes 192.

The pixel electrode 191 may be physically and electrically connected with the drain electrode 175 through the contact hole 185a of the first passivation layer 180a and the third passivation layer 180c to receive a voltage from the drain electrode 175.

According to another exemplary embodiment of the invention, a laminated position of the pixel electrode 191 and the common electrode 270 may be changed. In another exemplary embodiment, the pixel electrode 191 is disposed on the lower panel 100, and the common electrode 270 may be disposed on the upper panel 200. In addition, the structure and the layout of the pixel electrode 191 and the common electrode 270 may be various.

A plurality of sub light blocking members (also referred to as “colored members”) is disposed on the pixel electrode 191.

The sub light blocking member 325 may include an auxiliary light blocking part 327 which is disposed at a place corresponding to the contact hole 185a to cover the contact hole 185a. The auxiliary light blocking part 327 fills up a large step around the contact hole 185a to planarize a surface. Further, since the light blocking member 220 is removed around the contact hole 185a to provide the opening 22, light leakage may occur around the contact hole 185a. However, according to an exemplary embodiment of the invention, the auxiliary light blocking part 327 of the sub light blocking member 325 is provided to be overlapped with the opening 22 of the light blocking member 220 to effectively prevent light leakage around the contact hole 185a.

The sub light blocking member 325 may further include a spacer 326 which may maintain a separation distance between the lower panel 100 and the upper panel 200. The spacer 326 and the auxiliary light blocking part 327 may be separated from each other or connected to each other.

The sub light blocking member 325 may include a pigment such as black carbon, and include a photosensitive organic material.

The spacer 326 of the sub light blocking member 325 and the auxiliary light blocking part 327 may be provided in the same process by using one optical mask.

A transparent cover layer 320 is positioned on the sub light blocking member 325.

The cover layer 320 covers the sub light blocking member 325 to effectively prevent a pigment component such as a halogen element as an impurity from flowing or diffusing into the liquid crystal layer 3 from the sub light blocking member 325. Accordingly, it is possible to effectively prevent an afterimage due to the impurity flowing into the liquid crystal layer 3 and enhance reliability of the LCD. To this end, the cover layer 320 may cover an entire surface of the exposed sub light blocking member 325.

As illustrated in FIG. 5, the cover layer 320 may cover the adjacent spacer 325 and auxiliary light blocking part 327 and a separation portion therebetween together. However, in another exemplary embodiment, the cover layer 320, the cover layer 320 may cover only the spacer 326 and the auxiliary light blocking part 327, respectively.

The cover layer 320 does not include a pigment component, but may include a material without a reliability issue, for example, a transparent organic insulating material such as acrylate or a transparent inorganic insulating material. In the case where the cover layer 320 includes an organic insulating material, the cover layer 320 may include an organic insulating material having photosensitivity.

In an exemplary embodiment, the thickness of the cover layer 320 may be equal to or greater than about 1 μm, for example, but is not limited thereto.

Like the exemplary embodiment of FIGS. 1 to 3, the color filter 230, the light blocking member 220 and the sub light blocking member 325 are disposed on the lower panel 100 together with the TFT. As a result, alignment between the light blocking member 220 and the color filter 230 and the pixel electrode 191 and the TFT may be easily adjusted, thereby effectively reduces an alignment error. Accordingly, it is possible to effectively prevent light leakage or deterioration of an aperture ratio of the LCD due to misalignment between the constituent elements and enhance transmittance.

Since other descriptions are the same as those of the exemplary embodiment described above with reference to FIGS. 1 to 3, herein, a detailed description is omitted.

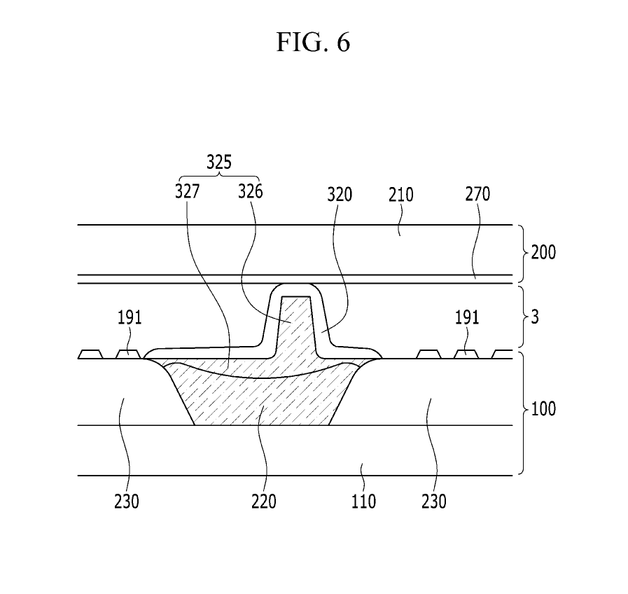

Then, an LCD according to an exemplary embodiment of the invention will be described with reference to FIG. 6. The same constituent elements as the exemplary embodiments described above designate the same reference numerals, and the duplicated description is omitted, but differences will be mainly described.

FIG. 6 is a cross-sectional view of an LCD according to an exemplary embodiment of the invention.

The LCD according to an exemplary embodiment of the invention includes a lower panel 100 and an upper panel 200 facing each other, and a liquid crystal layer 3 interposed therebetween.

The lower panel 100 includes an insulation substrate 110, a color filer 230 disposed on the insulation substrate 110, a light blocking member 220 disposed on the insulation substrate 110 and disposed between the color filters 230, and a pixel electrode 191 disposed on the color filter 230 and the light blocking member 220.

In an exemplary embodiment, a height of a part of the light blocking member 220 may be smaller than a height of the color filter 230, but is not limited thereto, and a height of an upper surface of the light blocking member 220 may be substantially uniform.

A sub light blocking member 325 may be further disposed on the light blocking member 220. The sub light blocking member 325 may include an auxiliary light blocking part 327, and further include a spacer 326. In this case, the spacer 326 and the auxiliary light blocking part 327 may be disposed on the same layer and connected to each other. In the case where a height of an upper surface of the light blocking member 220 is smaller than that of the color filter 230, a step of the light blocking member 220 is compensated by the sub light blocking member 325, and as a result, a distance between the lower panel 100 and the upper panel 200 may be uniformized.

A transparent cover layer 320 is disposed on the sub light blocking member 325.

The cover layer 320 covers the sub light blocking member 325 to effectively prevent a pigment component such as a halogen element as an impurity from flowing or diffusing into the liquid crystal layer 3 from the sub light blocking member 325. Accordingly, it is possible to effectively prevent an afterimage due to the impurity flowing into the liquid crystal layer 3 and enhance reliability of the LCD. To this end, the cover layer 320 may cover an entire surface of the exposed sub light blocking member 325.

The cover layer 320 does not include a pigment component, but may include a material without a reliability issue, for example, a transparent organic insulating material such as acrylate or a transparent inorganic insulating material. In the case where the cover layer 320 includes an organic insulating material, the cover layer 320 may include an organic insulating material having photosensitivity.

According to another exemplary embodiment of the invention, any one of the light blocking member 220 and the sub light blocking member 325 may be omitted.

The upper panel 200 may include a common electrode 270 disposed on an insulation substrate 210.

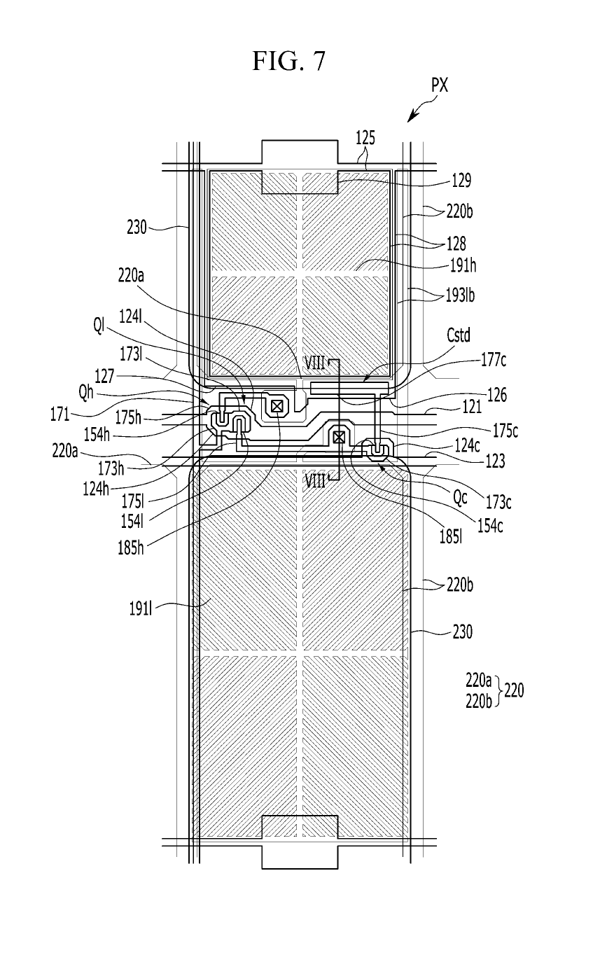

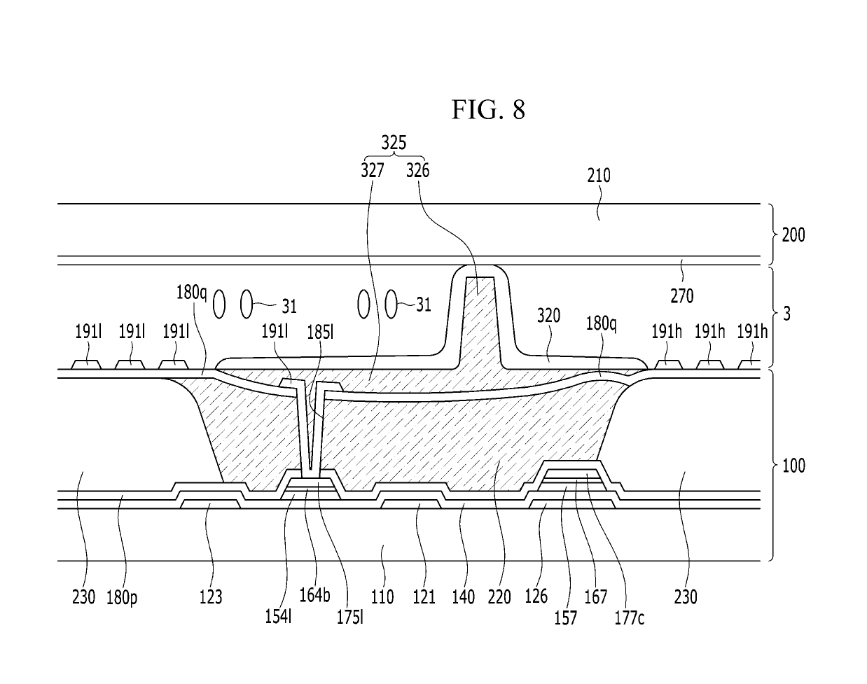

Then, an LCD according to an exemplary embodiment of the invention will be described with reference to FIGS. 7 and 8 in addition to FIG. 6 described above.

FIG. 7 is a layout view illustrating one pixel of an LCD according to an exemplary embodiment of the invention, and FIG. 8 is an exemplary embodiment of a cross-sectional view of the LCD of FIG. 7 taken along line VIII-VIII.

The LCD according to the exemplary embodiment of the invention includes a lower panel 100 and an upper panel 200 facing each other, and a liquid crystal layer 3 interposed between the two panels 100 and 200.

First, in the lower panel 100, a plurality of gate conductors including a plurality of gate lines 121, a plurality of step-down gate lines 123 and a plurality of storage electrode lines 125 is disposed on an insulation substrate 110. The gate line 121 and the step-down gate line 123 extend in a substantially horizontal direction to transfer gate signals. The gate line 121 includes a first gate electrode 124h and a second gate electrode 1241 protruding upward and downward, and the step-down gate line 123 includes a third gate electrode 124c protruding upward. The first gate electrode 124h and the second gate electrode 1241 are connected with each other to provide one protrusion. The storage electrode line 125 extends in a substantially horizontal direction to transfer a predetermined voltage such as a common voltage. The storage electrode line 125 includes storage electrodes 129 protruding upward and downward, a pair of vertical portions 128 extending downward to be substantially vertical to the gate line 121, and a horizontal portion 127 connecting ends of the pair of vertical portions 128 with each other. The horizontal portion 127 includes a capacitor electrode 126 extended downward.

A gate insulating layer 140 is disposed on the gate conductor.

A plurality of semiconductor stripes (not illustrated) is disposed on the gate insulating layer 140. The semiconductor stripes extend in a substantially vertical direction, and include first and second semiconductors 154h and 154l extending toward the first and second gate electrodes 124h and 1241 and connected with each other, and a third semiconductor 154c connected with the second semiconductor 154l. The third semiconductor 154c is extended to provide a fourth semiconductor 157.

A plurality of ohmic contacts 164b and 167 may be disposed on the semiconductor.

Data conductors including a plurality of data lines 171, a plurality of first drain electrodes 175h, a plurality of second drain electrodes 175l, and a plurality of third drain electrodes 175c are disposed on the ohmic contacts 164b and 167.

The data line 171 transfers a data signal and extends in a substantially vertical direction to cross the gate line 121 and the step-down gate line 123. Each data line 171 includes a first source electrode 173h and a second source electrode 1731 which extend toward the first gate electrode 124h and the second gate electrode 1241.

A first drain electrode 175h, a second drain electrode 175l, and a third drain electrode 175c include one wide end portion and the other rod-shaped end portion, respectively. The rod-shaped end portions of the first drain electrode 175h and the second drain electrode 175l are partially surrounded by the first source electrode 173h and the second source electrode 1731. One wide end portion of the second drain electrode 175l is again extended to provide a third source electrode 173c which is bent in a ‘U’-lettered shape. An extension 177c of the third drain electrode 175c is overlapped with the capacitor electrode 126 to provide a step-down capacitor Cstd, and the rod-shaped end portion is partially surrounded by the third source electrode 173c.

The first/second/third gate electrodes 124h/124l/124c, the first/second/third source electrodes 173h/173l/173c, and the first/second/third drain electrodes 175h/175l/175c provide first/second/third TFTs Qh/Ql/Qc together with the first/second/third semiconductor islands 154h/154l/154c, respectively.

A lower passivation layer 180p which may include an inorganic insulator such as silicon nitride or silicon oxide is disposed on the data conductor and the exposed portion of the semiconductors 154h, 154l, and 154c.

The color filter 230 and the light blocking member 220 are disposed on the lower passivation layer 180p.

The color filters 230 are disposed in most of the regions except for a place where the first TFT Qh, the second TFT Ql, and the third TFT Qc are disposed.

The light blocking member 220 includes a first light blocking part 220a and a second light blocking part 220b. The first light blocking part 220a may cover the gate line 121 and the step-down gate line 123, and may cover a region where the first TFT Qh, the second TFT Ql and the third TFT Qc are disposed. The second light blocking part 220b may extend along the data line 171.

In an exemplary embodiment, a height of a part of the light blocking member 220 may be smaller than a height of the color filter 230, but the invention is not limited thereto.

An upper passivation layer 180q may be disposed on the color filter 230 and the light blocking member 220. The upper passivation layer 180q may effectively prevent the color filter 230 and the light blocking member 220 from being lifted, and effectively prevent contamination of the liquid crystal layer 3 by an organic material such as a solvent flowing from the color filter 230 and the light blocking member 220.

A plurality of first contact holes 185h and a plurality of second contact holes 185l, which expose the wide end portion of the first drain electrode 175h and the wide end portion of the second drain electrode 175l, respectively, may be defined in the lower passivation layer 180p, the light blocking member 220 and the upper passivation layer 180q.

A first subpixel electrode 191h and a second subpixel electrode 1911 are disposed on the upper passivation layer 180q.

The first subpixel electrode 191h and the second subpixel electrode 1911 of one pixel PX are separated from each other with the gate lines 121 and 123 therebetween, and disposed above and below the pixel area based on the gate lines 121 and 123 to be adjacent to each other in a column direction. Each of the first subpixel electrode 191h and the second subpixel electrode 1911 may be shaped entirely as a rectangle. Each of the first subpixel electrode 191h and the second subpixel electrode 1911 may include a cross stem including a horizontal stem and a vertical stem substantially perpendicular to the horizontal stem, and a plurality of minute branches.

The second subpixel electrode 1911 may further include a protrusion 1931b extending to be adjacent to both edges of the first subpixel electrode 191h. The protrusion 1931b extends along the data line 171 to effectively prevent capacitive coupling between the data line 171 and the first subpixel electrode 191h.

The first subpixel electrode 191h and the second subpixel electrode 1911 receive data voltages from the first drain electrode 175h and the second drain electrode 175l through the first contact hole 185h and the second contact hole 185l, respectively. The first subpixel electrode 191h and the second subpixel electrode 1911 to which the data voltages are applied generate an electric field in the liquid crystal layer 3 together with the common electrode 270 of the upper panel 200 to determine directions of the liquid crystal molecules of the liquid crystal layer 3 between the two electrodes 191 and 270.

Sides of the minute branches of the first subpixel electrode 191h and the second subpixel electrode 1911 distort the electric field to make horizontal components which determine tilt directions of the liquid crystal molecules 31. Since each of the first subpixel electrode 191h and the second subpixel electrode 1911 includes four sub regions having different longitudinal directions of the minute branches, the tilt directions of the liquid crystal molecules 31 are approximately four, and as a result, a reference viewing angle of the LCD may be increased.

The first subpixel electrode 191h and the common electrode 270 provide a first liquid crystal capacitor together with the liquid crystal layer 3 therebetween, and the second subpixel electrode 1911 and the common electrode 270 provide a second liquid crystal capacitor together with the liquid crystal layer 3 therebetween. As a result, even after the first and second TFTs Qh and Ql are turned off, the applied voltage is maintained.

The first and second subpixel electrodes 191h and 1911 are overlapped with the storage electrode line 125 in addition to the storage electrode 129 to provide the first and second storage capacitors, and the first and second storage capacitors reinforce a voltage storage capacity of the first and second liquid crystal capacitors, respectively.

The capacitor electrode 126 and the expansion 177c of the third drain electrode 175c are overlapped with the gate insulating layer 140 to provide the step-down capacitor Cstd.

A sub light blocking member 325 may be disposed on the upper passivation layer 180q. The sub light blocking member 325 may include an auxiliary light blocking part 327, and further include a spacer 326. In this case, the spacer 326 and the auxiliary light blocking part 327 may be disposed on the same layer and connected to each other. The auxiliary light blocking part 327 is disposed on a region with the light blocking member 220. In the case where a height of an upper surface of the light blocking member 220 is smaller than that of the color filter 230, a step of the light blocking member 220 is compensated by the sub light blocking member 325, and as a result, a distance between the lower panel 100 and the upper panel 200 may be uniformized, and a function of effectively preventing light leakage of the light blocking member 220 may be reinforced.

A transparent cover layer 320 is disposed on the sub light blocking member 325.

The cover layer 320 covers the sub light blocking member 325 to effectively prevent a pigment component such as a halogen element as an impurity from flowing or diffusing into the liquid crystal layer 3 from the sub light blocking member 325. Accordingly, it is possible to effectively prevent an afterimage due to the impurity flowing into the liquid crystal layer 3 and enhance reliability of the LCD. To this end, the cover layer 320 may cover an entire surface of the exposed sub light blocking member 325.

In another exemplary embodiment, any one of the light blocking member 220 and the sub light blocking member 325 may be omitted.

On the first and second subpixel electrodes 191h and 1911, the exposed upper passivation layer 180q and the cover layer 320, an alignment layer (not illustrated) is disposed, and the alignment layer may be a vertical alignment (“VA”) layer.

In the upper panel 200, a common electrode 270 is disposed on an insulation substrate 210. An alignment layer (not illustrated) is disposed on the common electrode 270 and may be a VA layer.

Polarizers (not illustrated) may be attached to outer sides of the two panels 100 and 200, and transmissive axes of the two polarizers are substantially perpendicular to each other, and one transmissive axis thereof may be substantially parallel to the gate line 121.

The liquid crystal layer 3 has negative dielectric anisotropy, and the liquid crystal molecules 31 of the liquid crystal layer 3 may be aligned so that long axes thereof are vertical to the surfaces of the two panels 100 and 200 without applying the electric field.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A liquid crystal display, comprising:
a first substrate and a second substrate which face each other;
a thin film transistor disposed on the first substrate;
a pixel electrode connected to the thin film transistor;
a first light blocking member disposed on the pixel electrode; and
a cover layer disposed on the first light blocking member and covering the first light blocking member.

2. The liquid crystal display of claim 1, wherein:
the first light blocking member includes a pigment component, and the cover layer does not include the pigment component.

3. The liquid crystal display of claim 2, wherein:
the cover layer includes at least one of a transparent organic insulating material and a transparent inorganic insulating material.

4. The liquid crystal display of claim 3, wherein:
the cover layer further includes a spacer which maintains a separation distance between the first substrate and the second substrate.

5. The liquid crystal display of claim 4, further comprising:
a first passivation layer disposed between the thin film transistor and the pixel electrode,
wherein
a contact hole is defined in the first passivation layer and the contact hole exposes a drain electrode of the thin film transistor, and
the first light blocking member further includes a portion covering the contact hole.

6. The liquid crystal display of claim 5, further comprising:
a color filter disposed between the thin film transistor and the pixel electrode.

7. The liquid crystal display of claim 6, wherein:
a thickness of the cover layer is equal to or greater than about 1 micrometer.

8. The liquid crystal display of claim 3, wherein:
the first light blocking member further includes a spacer which maintains a separation distance between the first substrate and the second substrate.

9. The liquid crystal display of claim 8, further comprising:
a first passivation layer disposed between the thin film transistor and the pixel electrode,
wherein:
a contact hole is defined in the first passivation layer, and the contact hole exposes a drain electrode of the thin film transistor, and
the first light blocking member further includes a portion covering the contact hole.

10. The liquid crystal display of claim 9, further comprising:
a color filter disposed between the thin film transistor and the pixel electrode.

11. The liquid crystal display of claim 10, wherein:
a thickness of the cover layer is equal to or greater than about 1 micrometer.

12. The liquid crystal display of claim 3, further comprising:
a first passivation layer disposed between the thin film transistor and the pixel electrode,
wherein
a contact hole is defined in the first passivation layer, and the contact hole exposes a drain electrode of the thin film transistor, and
the first light blocking member further includes a portion covering the contact hole.

13. The liquid crystal display of claim 12, further comprising:
a second light blocking member disposed between the thin film transistor and the pixel electrode.

14. The liquid crystal display of claim 13, wherein:
an opening is defined in the second light blocking member, and a boundary of the opening is wider than that of the contact hole.

15. The liquid crystal display of claim 14, wherein:
the first light blocking member further includes a spacer which maintains a separation distance between the first substrate and the second substrate.

16. The liquid crystal display of claim 15, further comprising:
a color filter disposed between the thin film transistor and the pixel electrode.

17. The liquid crystal display of claim 16, wherein:
the cover layer includes a portion covering a separated area between the spacer and the portion of the first light blocking member covering the contact hole.

18. The liquid crystal display of claim 16, wherein:
a thickness of the cover layer is equal to greater than about 1 micrometer.

19. The liquid crystal display of claim 13, wherein:
the first light blocking member is disposed on the second light blocking member.

20. The liquid crystal display of claim 19, further comprising:
a color filter disposed between the thin film transistor and the pixel electrode,
wherein the second light blocking member includes a portion having a smaller height than that of the color filter.
